(19) United States
(12) Patent Application Publication
(10) Pub. No.: US 2013/0287929 A1
(43) Pub. Date: Oct. 31, 2013

(54) PRODUCTION OF SOLUBLE PROTEIN PRODUCTS FROM PULSES

(71) Applicants: Martin Schweizer, Winnipeg (CA); Kevin I. Segall, Winnipeg (CA)

(72) Inventors: Martin Schweizer, Winnipeg (CA); Kevin I. Segall, Winnipeg (CA)

(21) Appl. No.: 13/870,312

(22) Filed: Apr. 25, 2013

Related U.S. Application Data
(60) Provisional application No. 61/637,948, filed on Apr. 25, 2012.

(51) Int. Cl. A23J 1/14

(52) U.S. Cl. CPC A23J 1/14
USPC 426/656

(57) ABSTRACT

Protein products from pulses are obtained using procedures in which calcium chloride is used in multiple extractions of pulse protein source material.

### REFERENCE TO RELATED APPLICATION

This application claims priority under 35 USC 119(e) from U.S. Provisional Patent Application No. 61/637,948 filed Apr. 25, 2012.

### FIELD OF THE INVENTION

The present invention is directed to the production of protein products from pulses.

### BACKGROUND TO THE INVENTION

In U.S. patent application Ser. No. 13/103,528 filed May 9, 2011 (US Patent Publication No. 2011-0274797 published Nov. 10, 2011), Ser. No. 13/289,264 filed Nov. 4, 2011 (US Patent Publication No. 2012-0135117 published May 31, 2012) and Ser. No. 13/556,357 filed Jul. 24, 2012, assigned to the assignee hereof and the disclosures of which are incorporated herein by reference, there is described the production of pulse protein products having a protein content of at least about 60 wt % (N×6.25) d.b., preferably at least about 90 wt %, which produce preferably transparent, heat stable solutions at low pH values and which may be used for protein fortification of soft drinks, as well as other aqueous systems, without precipitation of protein.

The pulse protein products are produced by extracting a pulse protein source with an aqueous calcium chloride solution to cause solubilization of pulse protein from the protein source and to form an aqueous pulse protein solution, separating the aqueous pulse protein solution from residual pulse protein source, optionally diluting the pulse protein solution, adjusting the pH of the aqueous pulse protein solution to a pH of about 1.5 to about 4.4, preferably about 2 to about 4, to produce an acidified, preferably clear pulse protein solution, optionally concentrating the aqueous protein solution while maintaining the ionic strength substantially constant by using a selective membrane technique, optionally diafiltering the optionally concentrated pulse protein solution, and optionally drying the optionally concentrated and optionally diafiltered pulse protein solution.

In this process, calcium chloride or other calcium salt is used to extract the pulse protein from the protein source material and is a major cost input in the preparation of the pulse protein product.

### SUMMARY OF THE INVENTION

The present invention provides procedures whereby the overall quantity of calcium chloride or other calcium salt used to extract the pulse protein is reduced. In aspects of the present invention, a two-stage extraction procedure is effected.

In the procedure described in the above-mentioned patent applications, all of the extractable protein is solubilized in a given volume of calcium chloride solution having a calcium salt concentration of less than about 1.0 M, preferably about 0.10 to about 0.15 M. In the two-stage extraction procedure in accordance with one aspect of the invention, a portion of the pulse protein is initially extracted with the same volume of lower strength calcium chloride solution, typically about 0.05 M CaCl₂, and the wet, residual insoluble material is then re-extracted with a smaller volume of calcium chloride solution at a calcium salt concentration of less than about 1.0 M CaCl₂, preferably about 0.10 to about 0.15 M CaCl₂, more preferably about 0.13 M CaCl₂.

In another aspect of the invention utilizing a two-stage calcium salt extraction procedure, a portion of the pulse protein is initially extracted with water and insoluble material removed. Calcium chloride is added to the solution of water soluble material, typically to a concentration of about 0.05 M CaCl₂ and a precipitate forms. The wet, residual solids are collected then re-extracted with a smaller volume of calcium chloride solution at a calcium salt concentration of less than about 1.0 M CaCl₂, preferably about 0.10 to about 0.15 M CaCl₂, more preferably about 0.13 M CaCl₂.

In both aspects of the invention, the two calcium chloride containing protein solutions are combined for further processing according to the procedure outlined in the above-mentioned U.S. patent applications Ser. Nos. 13/103,528, 13/289,264, and 13/556,357.

In another aspect of the present invention, a procedure is used where a concentration step is employed prior to calcium salt addition. In this procedure, the pulse protein source is mixed with water and then separated into water-soluble and water-insoluble fractions. This separation is typically effected in two steps. First, the coarse water insoluble solids may be removed from the solution of water soluble materials using a decanter centrifuge. Second, finer solids not removed from solution by the decanter centrifuge may be removed using a disc stack centrifuge. The volume of the clarified water-soluble fraction then is reduced by membrane processing and the concentrated solution is recombined with the water-insoluble material collected from the decanter and disc stack centifuges or preferably just the finer solids collected by the disc stack centrifuge. Calcium chloride, at a concentration of less than about 1.0 M, preferably about 0.10 to about 0.15 M, more preferably about 0.13 M, is then introduced to the smaller volume fraction. Material insoluble after the calcium chloride addition is removed and the resulting protein solution is further processed, as described in the above-mentioned U.S. patent applications Ser. Nos. 13/103,528, 13/289,264, and 13/556,357.

The pulse protein products produced according to the processes herein are suitable, not only for protein fortification of acid media, but may be used in a wide variety of conventional applications of protein products, including but not limited to protein fortification of processed foods and beverages, emulsification of oils, as a body former in baked goods and foaming agent in products which entrap gases. In addition, the pulse protein products may be formed into protein fibers, useful in meat analogs and may be used as an egg white substitute or extender in food products where egg white is used as a binder. The pulse protein products may be used in nutritional supplements. The pulse protein products may also be used in dairy analogue products or products that are dairy/plant ingredient blends. Other uses of the pulse protein products are in pet foods, animal feed and in industrial and cosmetic applications and in personal care products.

### BRIEF DESCRIPTION OF DRAWINGS

FIG. 1 is a schematic flow sheet of one embodiment of the invention in which a two-stage extraction of pulse protein source with aqueous calcium chloride solution is effected;

FIG. 2 is a schematic flow sheet of another embodiment of the invention in which a two-stage extraction of pulse protein source initially with water and subsequently with aqueous calcium chloride solution is effected; and

FIG. 3 is a schematic flow sheet of a further embodiment of the invention in which a pulse protein source is initially extracted with water followed by subsequent concentration and addition of aqueous calcium chloride solution.

### GENERAL DESCRIPTION OF INVENTION

The initial step of the process of providing the pulse protein products involves solubilizing pulse protein from a pulse protein source. The pulses to which the invention may be applied include, but are not limited to, lentils, chickpeas, dry peas and dry beans. The pulse protein source may be pulses or any pulse product or by-product derived from the processing of pulses. For example, the pulse protein source may be a flour prepared by grinding an optionally dehulled pulse. As another example, the pulse protein source may be a protein-rich pulse fraction formed by dehulling and grinding a pulse and then air classifying the dehulled and ground material into starch-rich and protein-rich fractions. The pulse protein product recovered from the pulse protein source may be the protein naturally occurring in pulses or the proteinaceous material may be a protein modified by genetic manipulation but possessing characteristic hydrophobic and polar properties of the natural protein.

Protein solubilization from the pulse protein source material is effected most conveniently using calcium chloride solution, although solutions of other calcium salts may be used. In addition, other alkaline earth metal compounds may be used, such as magnesium salts. Further, extraction of the pulse protein from the pulse protein source may be effected using calcium salt solution in combination with another salt solution, such as sodium chloride. Additionally, extraction of the pulse protein from the pulse protein source may be effected using water or other salt solution, such as sodium chloride, with calcium salt subsequently being added to the aqueous pulse protein solution.

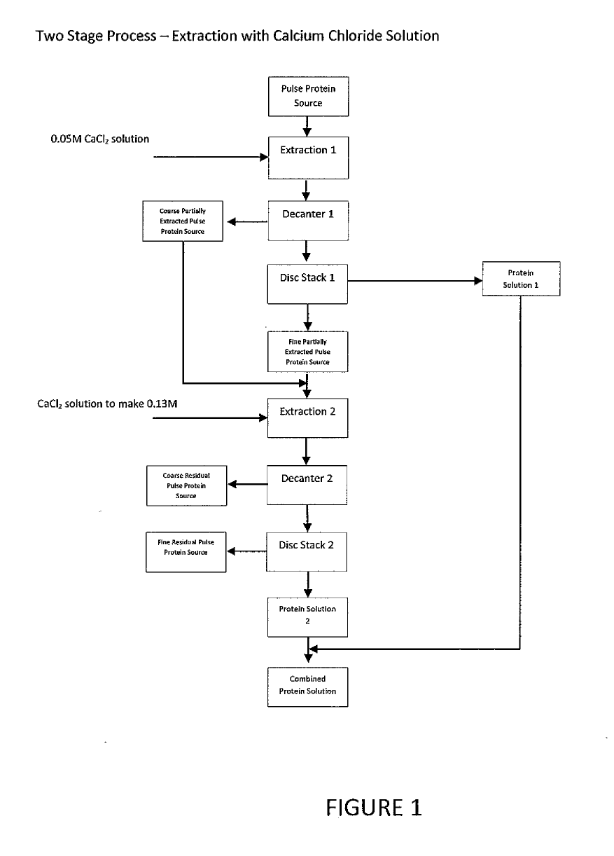

In one aspect of the present invention, illustrated in FIG. 1 and termed the two stage extraction procedure, a portion of the extractable protein is initially solubilized in a calcium salt solution, preferably aqueous calcium chloride solution, having a calcium salt concentration of about less than about 0.10 M, preferably having a concentration of about 0.05 M calcium salt. The concentration of pulse protein source in the calcium salt solution during the solubilization step may vary widely. Typically, about 6 to about 20 L of calcium salt solution are added per Kg of pulse protein material, preferably about 10 L per Kg of pulse protein source. After a separation step, the wet, partially extracted pulse protein source recovered is re-extracted with a smaller volume, generally less than about 5 L of calcium salt solution, preferably aqueous calcium chloride solution, per kg of wet, partially extracted pulse protein source, preferably less than about 2 L of calcium salt solution per kg of wet, partially extracted pulse protein source, with the calcium salt concentration of the mixture less than about 1.0 M, preferably about 0.10 M to about 0.15 M, more preferably about 0.13 M. The wet, partially extracted pulse protein source contains some entrapped calcium salt solution from the first extraction step. This must be factored in when preparing the second extraction at the desired calcium salt concentration. Following a separation step to capture the second protein extract solution, the two protein extract solutions then are combined for further processing, as described below.

The extraction operations may be carried out in a batch process or in a continuous process. These solubilization steps are effected at a temperature of from about 1° to about 100° C., preferably about 15° to about 65° C., more preferably about 20° to about 35° C.

The extraction steps are generally conducted at a pH of about 4.5 to about 11, preferably about 5 to about 7. The pH of the extraction system (pulse protein source and calcium salt solution or wet, residual insoluble material and calcium salt solution) may be adjusted to any desired value within the range of about 4.5 to about 11 for use in the extraction step by the use of any convenient food grade acid, usually hydrochloric acid or phosphoric acid, or food grade alkali, usually sodium hydroxide, as required.

The protein extraction step with the aqueous salt solution has the additional effect of solubilizing fats which may be present in the pulse protein source, which then results in the fats being present in the aqueous phase.

The protein solution resulting from combining the two protein solutions from the two extraction steps generally has a protein concentration of about 5 to about 50 g/L, preferably about 10 to about 50 g/L.

The aqueous calcium salt solutions may contain an antioxidant. The antioxidant may be any convenient antioxidant, such as sodium sulfite or ascorbic acid. The quantity of antioxidant employed may vary from about 0.01 to about 1 wt % of the solution, preferably about 0.05 wt %. The antioxidant serves to inhibit oxidation of any phenolics in the protein solution.

The aqueous phase resulting from each extraction step may be separated from the residual insoluble material, in any convenient manner, such as by employing a decanter centrifuge, followed by disc centrifugation and/or filtration, to remove residual insoluble material. The separation step may be conducted at any temperature within the range of about 1° to about 100° C., preferably about 15° to about 65° C., more preferably about 50° to about 60° C. The separated residual pulse protein source after the second extraction may be dried for disposal or further processed, such as to recover starch and/or residual protein. Residual protein may be recovered by re-extracting the separated residual pulse protein source with fresh calcium salt solution and the protein solution yielded upon clarification combined with the initial protein solution for further processing as described below. Alternatively, the separated residual pulse protein source may be processed by a conventional isoelectric precipitation process or any other convenient procedure to recover residual protein.

The aqueous pulse protein solution may be treated with an anti-foamer, such as any suitable food-grade, non-silicone based anti-foamer, to reduce the volume of foam formed upon further processing. The quantity of anti-foamer employed is generally greater than about 0.0003% w/v. Alternatively, the anti-foamer, in the quantity described may be added in the extraction steps.

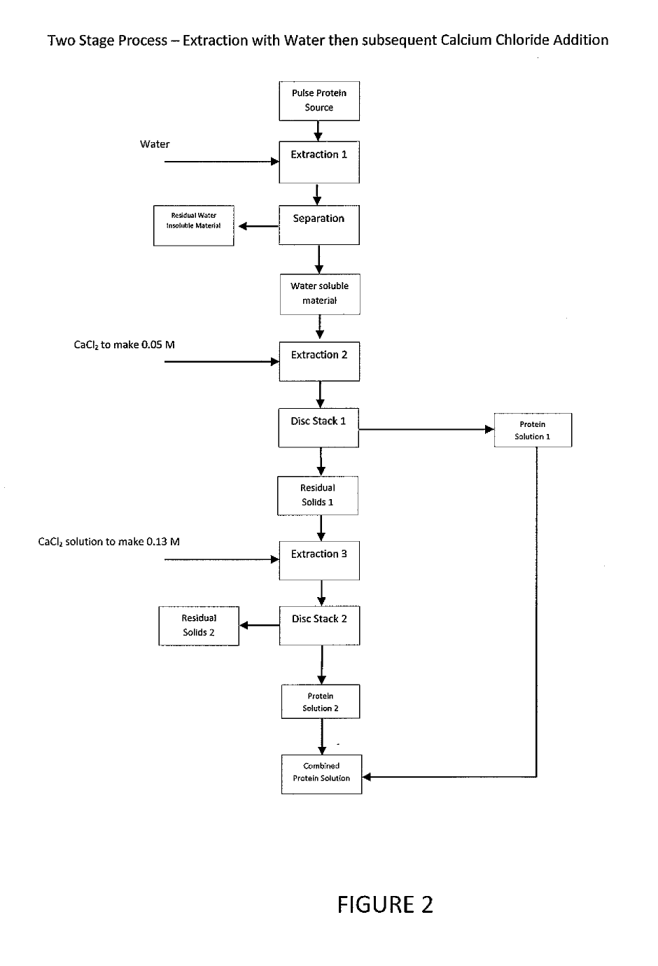

In another aspect of the present invention, the two stage calcium salt extraction procedure may be applied with the initial extraction step performed with water and subsequent addition of calcium salt, as illustrated in FIG. 2. The concentration of pulse protein source in the water during the solubilization step may vary widely. Typically, about 6 to about 20 L of water are added per Kg of pulse protein material, preferably about 10 L water per Kg of pulse protein source. A separation step is then employed to provide a solution of water soluble material. Calcium salt, preferably in the form of a concentrated solution of preferably calcium chloride, is then added to this solution of water soluble material to provide a calcium salt concentration of about less than about 0.10 M, preferably about 0.05 M calcium salt. The calcium salt addition results in the formation of a precipitate that is mainly calcium phytate but may also contain some protein that was water soluble, but not soluble at the particular concentration of calcium salt. After a separation step, the wet, residual solids recovered then are re-extracted with a smaller volume, generally less than about 5 L of calcium salt solution, preferably aqueous calcium chloride solution, per kg of wet, residual solids, preferably less than about 2 L of calcium salt solution per kg of wet, residual solids, with the calcium salt concentration of the mixture less than about 1.0 M, preferably about 0.10 M to about 0.15 M, more preferably about 0.13 M. The wet, residual solids contains some entrapped calcium salt solution from the first extraction step. This must be factored in when preparing the second extraction at the desired calcium salt concentration. Following a separation step to capture the second protein extract solution, the two clarified, calcium salt containing protein solutions then are combined for further processing, as described below.

The extraction operations may be carried out in a batch process or in a continuous process. These solubilization steps are effected at a temperature of from about 1° to about 100° C., preferably about 15° to about 65° C., more preferably about 20° to about 35° C.

The extraction steps are generally conducted at a pH of about 4.5 to about 11, preferably about 5 to about 7. The pH of the extraction system (pulse protein source and water or wet, residual solids and calcium salt solution) may be adjusted to any desired value within the range of about 4.5 to about 11 for use in the extraction step by the use of any convenient food grade acid, usually hydrochloric acid or phosphoric acid, or food grade alkali, usually sodium hydroxide, as required.

The initial protein extraction step with water has the additional effect of solubilizing fats which may be present in the pulse protein source, which then results in the fats being present in the aqueous phase. The protein solution resulting from combining the two clarified calcium salt containing protein solutions generally has a protein concentration of about 5 to about 50 g/L, preferably about 10 to about 50 g/L.

The water used for the initial extraction or the aqueous calcium salt solutions used in subsequent steps may contain an antioxidant. The antioxidant may be any convenient antioxidant, such as sodium sulfite or ascorbic acid. The quantity of antioxidant employed may vary from about 0.01 to about 1 wt % of the solution, preferably about 0.05 wt %. The antioxidant serves to inhibit oxidation of any phenolics in the protein solution.

In the initial water extraction, the aqueous phase is separated from the residual water insoluble material by any convenient manner, typically by employing a decanter centrifuge. If desired, a disc stack centrifuge may subsequently be used to remove residual, finer water insoluble material. The calcium salt containing protein solutions may be separated from the residual solids in any convenient manner, typically by disc centrifugation and/or filtration. The separation steps may be conducted at any temperature within the range of about 1° to about 100° C., preferably about 15° to about 65° C., more preferably about 50° to about 60° C. The residual insoluble material separated in the initial water extraction may be dried for disposal or further processed, such as to recover starch and/or residual protein. Residual protein may be recovered by re-extracting the separated residual water insoluble material with calcium salt solution and the protein solution yielded upon clarification combined with the other clarified calcium salt containing protein solutions for further processing as described below. Alternatively, the separated residual water insoluble material may be processed by a conventional isoelectric precipitation process or any other convenient procedure to recover residual protein.

The aqueous pulse protein solution may be treated with an anti-foamer, such as any suitable food-grade, non-silicone based anti-foamer, to reduce the volume of foam formed upon further processing. The quantity of anti-foamer employed is generally greater than about 0.0003% w/v. Alternatively, the anti-foamer, in the quantity described may be added in the extraction steps.

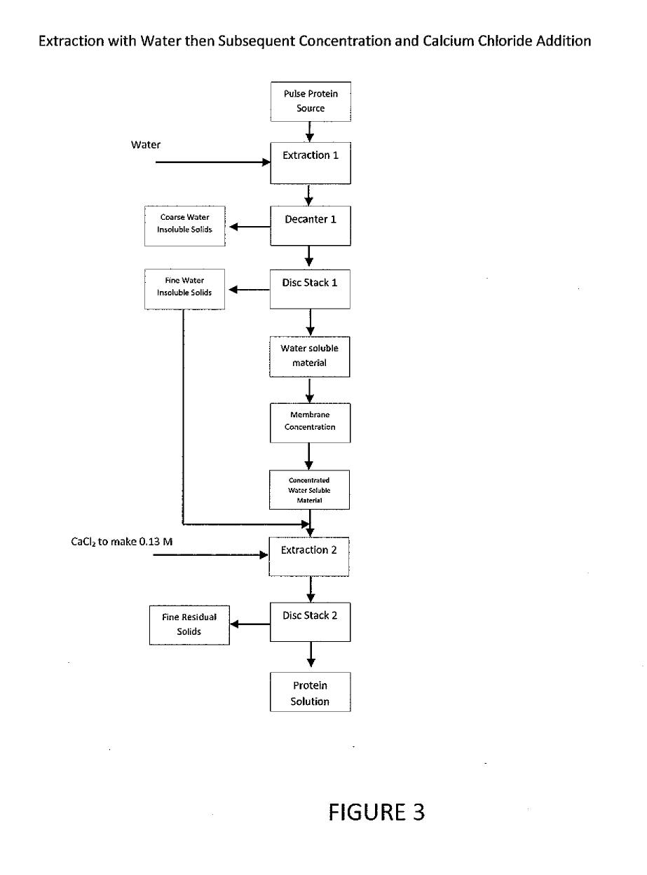

In another aspect of the present invention, illustrated in FIG. 3, the pulse protein source material is initially mixed with water and is separated by centrifugation or other convenient separation technique into water-soluble and water-insoluble fractions. Typically a two step separation is employed with coarse insoluble solids removed from the solution of water soluble material using a decanter centrifuge and then finer solids removed by a disc stack centrifuge or by filtration. Clarification of the protein solution facilitates subsequent membrane processing.

The concentration of pulse protein source in the water during the solubilization step may vary widely. Typically, about 6 to about 20 L of water are added per Kg of pulse protein material, preferably about 10 L water per Kg of pulse protein source.

The water extraction operation may be carried out in a batch process or in a continuous process. The solubilization is effected at a temperature of from about 1° to about 100° C., preferably about 15° to about 65° C., more preferably about 20° to about 35° C.

The water extraction is generally conducted at a pH of about 4.5 to about 11, preferably about 5 to about 7. The pH of the extraction system may be adjusted to any desired value within the range of about 4.5 to about 11 for use in the extraction step by the use of any convenient food grade acid, usually hydrochloric acid or phosphoric acid, or food grade alkali, usually sodium hydroxide, as required.

The water extraction step has the additional effect of solubilizing fats which may be present in the pulse protein source, which then results in the fats being present in the aqueous phase.

The volume of the water soluble fraction then is reduced by membrane filtration, such as ultrafiltration, to provide a concentrated solution having about 25 to about 75%, preferably about 25 to about 50% of the volume of the original water soluble fraction.

The concentration step may be effected in any convenient manner consistent with batch or continuous operation, such as by employing any convenient selective membrane technique, such as ultrafiltration or diafiltration, using membranes, such as hollow-fibre membranes or spiral-wound membranes, with a suitable molecular weight cut-off, such as about 1,000 to about 1,000,000 Daltons, preferably about 1,000 to about 100,000 Daltons, having regard to differing membrane materials and configurations, and, for continuous operation, dimensioned to permit the desired degree of concentration as the aqueous protein solution passes through the membranes.

The concentrated water soluble fraction then is recombined with the water insoluble coarse and fine solids resulting from the initial water extraction or preferably just the water insoluble fine solids. Calcium salt, preferably in the form of a concentrated calcium salt solution of preferably calcium chloride, then is added to the sample to provide a calcium salt concentration of less than about 1.0 M, preferably about 0.10 M to about 0.15 M, more preferably about 0.13 M. Material which is insoluble after the calcium salt addition is removed by decanter and/or disc centrifugation or by other convenient technique, providing a clarified, calcium salt containing protein solution for further processing as described below.

The protein solution resulting from the post-calcium salt addition separation step generally has a protein concentration of about 5 to about 100 g/L, preferably about 10 to about 60 g/L.

An antioxidant may be added with the extraction water or along with the calcium salt. The antioxidant may be any convenient antioxidant, such as sodium sulfite or ascorbic acid. The quantity of antioxidant employed may vary from about 0.01 to about 1 wt % of the solution, preferably about 0.05 wt %. The antioxidant serves to inhibit oxidation of any phenolics in the protein solution.

The separation steps described may be conducted at any temperature within the range of about 1° to about 100° C., preferably about 15° to about 65° C., more preferably about 50° to about 60° C. The separated residual insoluble material resulting from the water extraction or the calcium salt addition may be dried for disposal or further processed, such as to recover starch and/or residual protein. Residual protein may be recovered by re-extracting the separated residual insoluble material with fresh calcium salt solution and the protein solution yielded upon clarification combined with the initial clarified calcium salt containing protein solution for further processing as described below. Alternatively, the separated residual pulse protein source may be processed by a conventional isoelectric precipitation process or any other convenient procedure to recover residual protein.

The aqueous pulse protein solution may be treated with an anti-foamer, such as any suitable food-grade, non-silicone based anti-foamer, to reduce the volume of foam formed upon further processing. The quantity of anti-foamer employed is generally greater than about 0.0003% w/v. Alternatively, the anti-foamer may be added along with the calcium salt or added in the initial water extraction step.

The aqueous protein solutions arising from both the two-stage extraction procedures and the procedure in which an initial water extract is concentrated before calcium salt addition may be both be further processed using the steps indicated below.

The separated aqueous pulse protein solution may be subject to a defatting operation, if required, as described in U.S. Pat. Nos. 5,844,086 and 6,005,076, assigned to the assignee hereof and the disclosures of which are incorporated herein by reference. Alternatively, defatting of the separated aqueous pulse protein solution may be achieved by any other convenient procedure.

The aqueous pulse protein solution may be treated with an adsorbent, such as powdered activated carbon or granulated activated carbon, to remove colour and/or odour compounds. Such adsorbent treatment may be carried out under any convenient conditions, generally at the ambient temperature of the separated aqueous protein solution. For powdered activated carbon, an amount of about 0.025% to about 5% w/v, preferably about 0.05% to about 2% w/v, is employed. The adsorbing agent may be removed from the pulse protein solution by any convenient means, such as by filtration.

The resulting aqueous pulse protein solution may be diluted generally with about 0.1 to about 10 volumes, preferably about 0.5 to about 2 volumes of aqueous diluent, in order to decrease the conductivity of the aqueous pulse protein solution to a value of generally below about 105 mS, preferably about 4 to about 21 mS. Such dilution is usually effected using water, although dilute salt solution, such as sodium chloride or calcium chloride, having a conductivity up to about 3 mS, may be used.

The diluent with which the pulse protein solution is mixed generally has the same temperature as the pulse protein solution, but the diluent may have a temperature of about 1° to about 100° C., preferably about 15° to about 65° C., more preferably about 50° to about 60° C.

The optionally diluted pulse protein solution then is adjusted in pH to a value of about 1.5 to about 4.4, preferably about 2 to about 4, by the addition of any suitable food grade acid, such as hydrochloric acid or phosphoric acid, to result in an acidified aqueous pulse protein solution, preferably a clear acidified aqueous pulse protein solution.

The acidified aqueous pulse protein solution has a conductivity of generally below about 110 mS for a diluted pulse protein solution, or generally below about 115 mS for an undiluted pulse protein solution, in both cases preferably about 4 to about 26 mS.

As an alternative for the two stage extraction procedures, instead of combining the first and second calcium salt containing protein extract solutions prior to the optional dilution and the acidification steps, the first extract solution may be optionally diluted and acidified and then combined with the second extract solution. The combined sample may then be optionally diluted and acidified. As a further alternative, the two protein streams may be optionally diluted and acidified separately according to the parameters described above, and then combined for further processing. As another further alternative, instead of separating the second calcium salt containing protein extract solution from the residual pulse protein source or solids, the second protein solution and the residual pulse protein source or solids may be optionally diluted and acidified together with or without the addition of the first calcium salt containing protein extract solution. The acidified aqueous pulse protein solution is then clarified and separated from the residual pulse protein source or solids by any convenient technique as discussed above. If the first protein extract solution was not combined with the second protein extract solution and residual pulse protein source or solids then the first protein extract solution is optionally diluted and acidified then combined with the clarified, acidic second protein extract solution.

As an alternative for the procedure where the protein solution is concentrated before calcium addition, the optional dilution and acidification steps may be performed on the concentrated protein solution and insoluble residual solids present after calcium salt addition. The acidified aqueous pulse protein solution is then clarified and separated from the residual insoluble solids by any convenient technique as discussed above.

The acidified aqueous pulse protein solution may be subjected to a heat treatment to inactivate heat labile anti-nutritional factors, such as trypsin inhibitors, present in such solution as a result of extraction from the pulse protein source material during the extraction step. Such a heating step also provides the additional benefit of reducing the microbial load. Generally, the protein solution is heated to a temperature of about 70° to about 160° C., preferably about 80° to about 120° C., more preferably about 85° to about 95° C., for about 10 seconds to about 60 minutes, preferably about 10 seconds to about 5 minutes, more preferably about 30 seconds to about 5 minutes. The heat treated acidified pulse protein solution then may be cooled for further processing as described below, to a temperature of about 2° to about 65° C., preferably about 50° C. to about 60° C.

If the optionally diluted, acidified and optionally heat treated pulse protein solution is not transparent it may be clarified by any convenient procedure such as filtration or centrifugation.

The resulting acidified aqueous pulse protein solution may be directly dried to produce a pulse protein product. In order to provide a pulse protein product having a decreased impurities content and a reduced salt content, such as a pulse protein isolate, the acidified aqueous pulse protein solution may be processed as described below prior to drying.

The acidified aqueous pulse protein solution may be concentrated to increase the protein concentration thereof while maintaining the ionic strength thereof substantially constant. Such concentration generally is effected to provide a concentrated pulse protein solution having a protein concentration of about 50 to about 300 g/L, preferably about 100 to about 200 g/L.

The concentration step may be effected in any convenient manner consistent with batch or continuous operation, such as by employing any convenient selective membrane technique, such as ultrafiltration or diafiltration, using membranes, such as hollow-fibre membranes or spiral-wound membranes, with a suitable molecular weight cut-off, such as about 1,000 to about 1,000,000 Daltons, preferably about 1,000 to about 100,000 Daltons, having regard to differing membrane materials and configurations, and, for continuous operation, dimensioned to permit the desired degree of concentration as the aqueous protein solution passes through the membranes.

As is well known, ultrafiltration and similar selective membrane techniques permit low molecular weight species to pass therethrough while preventing higher molecular weight species from so doing. The low molecular weight species include not only the ionic species of the salt but also low molecular weight materials extracted from the source material, such as carbohydrates, pigments, low molecular weight proteins and anti-nutritional factors, such as trypsin inhibitors, which are themselves low molecular weight proteins. The molecular weight cut-off of the membrane is usually chosen to ensure retention of a significant proportion of the protein in the solution, while permitting contaminants to pass through having regard to the different membrane materials and configurations.

The concentrated pulse protein solution then may be subjected to a diafiltration step using water or a dilute saline solution. The diafiltration solution may be at its natural pH or at a pH equal to that of the protein solution being diafiltered or at any pH value in between. Such diafiltration may be effected using from about 1 to about 40 volumes of diafiltration solution, preferably about 2 to about 25 volumes of diafiltration solution. In the diafiltration operation, further quantities of contaminants are removed from the aqueous pulse protein solution by passage through the membrane with the permeate. This purifies the aqueous protein solution and may also reduce its viscosity. The diafiltration operation may be effected until no significant further quantities of contaminants or visible colour are present in the permeate or until the retentate has been sufficiently purified so as, when dried, to provide a pulse protein isolate with a protein content of at least about 90 wt % (N×6.25) d.b. Such diafiltration may be effected using the same membrane as for the concentration step. However, if desired, the diafiltration step may be effected using a separate membrane with a different molecular weight cut-off, such as a membrane having a molecular weight cut-off in the range of about 1,000 to about 1,000,000 Daltons, preferably about 1,000 to about 100,000 Daltons, having regard to different membrane materials and configuration.

Alternatively, the diafiltration step may be applied to the acidified aqueous protein solution prior to concentration or to partially concentrated acidified aqueous protein solution. Diafiltration may also be applied at multiple points during the concentration process. When diafiltration is applied prior to concentration or to the partially concentrated solution, the resulting diafiltered solution may then be fully concentrated. The viscosity reduction achieved by diafiltering multiple times as the protein solution is concentrated may allow a higher final, fully concentrated protein concentration to be achieved. This reduces the volume of material to be dried.

The concentration step and the diafiltration step may be effected herein in such a manner that the pulse protein product subsequently recovered contains less than about 90 wt % protein (N×6.25) d.b., such as at least about 60 wt % protein (N×6.25) d.b. By partially concentrating and/or partially diafiltering the aqueous pulse protein solution, it is possible to only partially remove contaminants. This protein solution may then be dried to provide a pulse protein product with lower levels of purity. The pulse protein product is highly soluble and able to produce protein solutions, preferably clear protein solutions, under acidic conditions.

An antioxidant may be present in the diafiltration medium during at least part of the diafiltration step. The antioxidant may be any convenient antioxidant, such as sodium sulfite or ascorbic acid. The quantity of antioxidant employed in the diafiltration medium depends on the materials employed and may vary from about 0.01 to about 1 wt %, preferably about 0.05 wt %. The antioxidant serves to inhibit the oxidation of any phenolics present in the pulse protein solution.

The optional concentration step and the optional diafiltration step may be effected at any convenient temperature, generally about 2° to about 65° C., preferably about 50° to about 60° C., and for the period of time to effect the desired degree of concentration. The temperature and other conditions used to some degree depend upon the membrane equipment used to effect the membrane processing, the desired protein concentration of the solution and the efficiency of the removal of contaminants to the permeate.

As alluded to earlier, pulses contain anti-nutritional trypsin inhibitors. The level of trypsin inhibitor activity in the final pulse protein product can be controlled by the manipulation of various process variables.

As noted above, heat treatment of the acidified aqueous pulse protein solution may be used to inactivate heat-labile trypsin inhibitors. The partially concentrated or fully concentrated acidified pulse protein solution may also be heat treated to inactivate heat labile trypsin inhibitors. When the heat treatment is applied to the partially concentrated acidified pulse protein solution, the resulting heat treated solution may then be additionally concentrated.

In addition, the concentration and/or diafiltration steps may be operated in a manner favorable for removal of trypsin inhibitors in the permeate along with the other contaminants. Removal of the trypsin inhibitors is promoted by using a membrane of larger pore size, such as about 30,000 to about 1,000,000 Da, operating the membrane at elevated temperatures, such as about 30° to about 65° C., preferably about 50° to about 60° C. and employing greater volumes of diafiltration medium, such as about 10 to about 40 volumes.

Acidifying and membrane processing the pulse protein solution at a lower pH, such as about 1.5 to about 3, may reduce the trypsin inhibitor activity relative to processing the solution at higher pH, such as about 3 to about 4.4. When the protein solution is concentrated and diafiltered at the low end of the pH range, it may be desired to raise the pH of the retentate prior to drying. The pH of the concentrated and diafiltered protein solution may be raised to the desired value, for example pH 3, by the addition of any convenient food grade alkali, such as sodium hydroxide.

Further, a reduction in trypsin inhibitor activity may be achieved by exposing pulse materials to reducing agents that disrupt or rearrange the disulfide bonds of the inhibitors. Suitable reducing agents include sodium sulfite, cysteine and N-acetylcysteine.

The addition of such reducing agents may be effected at various stages of the overall process. The reducing agent may be added with the pulse protein source material in the extraction step, may be added to the clarified aqueous pulse protein solution following removal of residual insoluble material, may be added to the diafiltered retentate before drying or may be dry blended with the dried pulse protein product. The addition of the reducing agent may be combined with the heat treatment step and membrane processing steps, as described above.

If it is desired to retain active trypsin inhibitors in the concentrated protein solution, this can be achieved by eliminating or reducing the intensity of the heat treatment step, not utilizing reducing agents, operating the concentration and diafiltration steps at the higher end of the pH range, such as about 3 to about 4.4, utilizing a concentration and diafiltration membrane with a smaller pore size, operating the membrane at lower temperatures and employing fewer volumes of diafiltration medium.

The optionally concentrated and optionally diafiltered protein solution may be subject to a further defatting operation, if required, as described in U.S. Pat. Nos. 5,844,086 and 6,005,076. Alternatively, defatting of the optionally concentrated and optionally diafiltered protein solution may be achieved by any other convenient procedure.

The optionally concentrated and optionally diafiltered aqueous protein solution may be treated with an adsorbent, such as powdered activated carbon or granulated activated carbon, to remove colour and/or odour compounds. Such adsorbent treatment may be carried out under any convenient conditions, generally at the ambient temperature of the protein solution. For powdered activated carbon, an amount of about 0.025% to about 5% w/v, preferably about 0.05% to about 2% w/v, is employed. The adsorbent may be removed from the pulse protein solution by any convenient means, such as by filtration.

The optionally concentrated and optionally diafiltered aqueous pulse protein solution may be dried by any convenient technique, such as spray drying or freeze drying. A pasteurization step may be effected on the pulse protein solution prior to drying. Such pasteurization may be effected under any desired pasteurization conditions. Generally, the optionally concentrated and optionally diafiltered pulse protein solution is heated to a temperature of about 55° to about 70° C., preferably about 60° to about 65° C., for about 30 seconds to about 60 minutes, preferably about 10 minutes to about 15 minutes. The pasteurized pulse protein solution then may be cooled for drying, preferably to a temperature of about 25° to about 40° C.

The dry pulse protein product has a protein content greater than about 60 wt %. Preferably, the dry pulse protein product is an isolate with a protein content in excess of about 90 wt % protein, preferably at least about 100 wt %, (N×6.25) d.b.

The pulse protein product produced herein is soluble in an acidic aqueous environment, making the product ideal for incorporation into beverages, both carbonated and uncarbonated, to provide protein fortification thereto. Such beverages have a wide range of acidic pH values, ranging from about 2.5 to about 5. The pulse protein product provided herein may be added to such beverages in any convenient quantity to provide protein fortification to such beverages, for example, at least about 5 g of the pulse protein per serving. The added pulse protein product dissolves in the beverage and the haze level of the beverage is not increased by thermal processing. The pulse protein product may be blended with dried beverage prior to reconstitution of the beverage by dissolution in water. In some cases, modification to the normal formulation of the beverages to tolerate the composition of the invention may be necessary where components present in the beverage may adversely affect the ability of the composition of the invention to remain dissolved in the beverage.

### EXAMPLES

### Example 1

This Example describes one embodiment of the present invention utilizing a two-stage extraction procedure, illustrated in FIG. 2.

42 kg of yellow split pea flour was combined with 300 L of reverse osmosis purified (RO) water and the mixture stirred for 30 minutes at 29.5° C. Insoluble material was removed and the sample partially clarified by centrifugation, yielding 284.4 L of protein solution having a protein concentration of 2.72 wt %. To this protein solution was added 1.62 kg of calcium chloride pellets (95.5%) and the sample stirred for 30 minutes. Centrifugation was used to separate the insoluble material (designated desludger solids 1) from the protein extract solution (designated centrate 1). 241 L of centrate 1 was obtained having a protein concentration of 1.36 wt %. The pH of this solution was reduced to 2.70 by the addition of 1:1 diluted HCl and the sample set aside. 45.9 kg of desludger solids 1 was obtained having a protein concentration of 8.73 wt %. These solids were mixed with 3.42 kg of CaCl₂ solution (1 part CaCl₂ pellets (95.5%) plus 2 parts water) for 30 minutes. Centrifugation was again used to separate the insoluble material (designated desludger solids 2) from the protein extract solution (designated centrate 2). 32.12 kg of centrate 2 was obtained having a protein concentration of 3.50 wt %. The centrate 2 was mixed with centrate 1 and the pH of the combined sample lowered from 3.20 to 2.80 by the addition of 1:1 diluted HCl. The protein solution was then clarified by filtration to yield a filtered protein solution having a protein concentration of 0.96 wt %.

312 L of filtered protein solution was reduced in volume to 51 L by concentration on a polyethersulfone (PES) membrane having a molecular weight cutoff of 5,000 Daltons operated at a temperature of approximately 57° C. At this point the protein solution, with a protein content of 5.34 wt % was diafiltered with 110 L of RO water, with the diafiltration operation conducted at approximately 58° C. The diafiltered protein solution was then concentrated to a volume of 25.5 L and diafiltered with an additional 130 L of RO water, with the diafiltration operation conducted at approximately 60° C. The protein solution before spray drying was recovered in a yield of 31.9% of the protein solution before calcium addition and a yield of 28.2% of the protein in the split pea flour. The concentrated and diafiltered protein solution was then dried to yield a product found to have a protein content of 102.65 wt % (N×6.25) d.b. The product was given designation YP07-C12-12A YP701.

The weight of calcium chloride pellets (95.5%) used to produce the YP07-C12-12A YP701 was 39.1% less than would have been used if the 42 kg of yellow split pea flour had been extracted with 300 L of 0.13M CaCl₂.

### Example 2

This Example illustrates another embodiment of the present invention utilizing a two-stage extraction procedure, illustrated in FIG. 2.

47.24 kg of yellow split pea flour was combined with 300 L of RO water and the mixture stirred for 30 minutes at 29.9° C. Insoluble material was removed and the sample partially clarified by centrifugation, yielding 280 L of protein solution having a protein concentration of 3.17 wt %. To this protein solution was added 1.626 kg of calcium chloride pellets (95.5%) and the sample stirred for 30 minutes. Centrifugation was used to separate the insoluble material (designated desludger solids 1) from the protein extract solution (designated centrate 1). 226.2 L of centrate 1 was obtained having a protein concentration of 1.60 wt %. The pH of this solution was reduced to 2.84 by the addition of 1:1 diluted HCl and the sample set aside. 53.80 kg of desludger solids 1 was obtained having a protein concentration of 8.84 wt %. These solids were mixed with 107.6 L of 0.164 M CaCl₂ solution for 30 minutes. Centrifugation was again used to separate the insoluble material (designated desludger solids 2) from the protein extract solution (designated centrate 2). 144.18 L of centrate 2 was obtained having a protein concentration of 1.39 wt %. The centrate 2 was mixed with centrate 1 and the pH of the combined sample lowered from 3.75 to 3.01 by the addition of 1:1 diluted HCl. The protein solution was then clarified by filtration to yield a filtered protein solution, having a protein concentration of 1.00 wt %.

410 L of filtered protein solution was reduced in volume to 70 L by concentration on a polyethersulfone (PES) membrane having a molecular weight cutoff of 3,000 Daltons, operated at a temperature of approximately 55° C. At this point the protein solution, with a protein content of 5.00 wt % was diafiltered with 140 L of RO water, with the diafiltration operation conducted at approximately 59° C. The diafiltered protein solution was then concentrated to a volume of 28 L and diafiltered with an additional 140 L of RO water, with the diafiltration operation conducted at approximately 60° C. The protein solution before spray drying was recovered in a yield of 33.0% of the protein solution before calcium addition and a yield of 29.1% of the protein in the split pea flour. The concentrated and diafiltered protein solution was then dried to yield a product found to have a protein content of 101.92 wt % (N×6.25) d.b. The product was given designation YP07-C14-12A YP701.

The weight of calcium chloride pellets (95.5%) used to produce the YP07-C14-12A YP701 was 18.8% less than would have been used if the 47.24 kg of yellow split pea flour had been extracted with 300 L of 0.13M CaCl₂.

### Example 3

This Example describes one embodiment of the present invention utilizing a two-stage extraction procedure, illustrated in FIG. 1.

60 g of yellow split pea flour was combined with 600 ml of 0.05M calcium chloride solution and the mixture stirred for 30 minutes at ambient temperature. Centrifugation was used to separate the insoluble material (designated residual 1) from the protein extract solution (designated centrate 1). 545.81 g of centrate 1 was obtained having a protein concentration of 0.97 wt %. 108.66 g of residual 1 was obtained having a protein concentration of 7.97 wt %. An aliquot of 94.34 g of these solids were mixed with 94.34 ml of 0.178M CaCl₂ solution (giving an overall calcium chloride concentration of about 0.13M) for 30 minutes. Centrifugation was again used to separate the insoluble material (designated residual 2) from the protein extract solution (designated centrate 2). 96.22 g of centrate 2 was obtained having a protein concentration of 2.09 wt %. The two extractions combined, presuming the entire sample of residual 1 was re-extracted, were determined to have solubilized about 61% of the protein in the initial flour sample. This is very similar to the amount of protein solubilized by a single extraction of 60 g of yellow pea flour using 600 ml of 0.13M calcium chloride. However, the two stage extraction process utilized in this Example required 37% less calcium chloride than the single extraction.

### Example 4

This Example illustrates one embodiment of the present invention utilizing a concentration step prior to calcium salt addition, illustrated in FIG. 3.

42.0 kg of yellow split pea flour was combined with 300 L of RO water and the mixture stirred for 30 minutes at ambient temperature. 75.98 kg of insoluble material, having a protein concentration of 4.26 wt %, was removed by centrifugation to yield 304 L of protein solution having a protein concentration of 2.42 wt %. This protein solution was further clarified by filtration to yield 278 L of filtered protein solution having a protein concentration of 2.31 wt %. The 278 L of filtered protein solution was reduced in volume to 150 L by concentration on a PES membrane having a molecular weight cutoff of 10,000 Daltons, operated at a temperature of approximately 29° C. This concentrated protein solution had a protein concentration of 2.94 wt %.

The 150 L of concentrated protein solution was combined with the 75.98 kg of insoluble material from the initial centrifugation step and 2.96 kg of calcium chloride pellets (95.5%) and mixed for 15 minutes. Insoluble material was again removed by centrifugation to yield 169 L of protein solution having a protein concentration of 2.10 wt %. This protein solution was combined with 248 L of RO water and the pH of the mixture lowered to 3.06 with 1:1 diluted HCl. The diluted and pH adjusted protein solution was then further clarified by filtration to yield a filtered protein solution having a protein concentration of 0.59 wt %. 400 L of filtered protein solution was reduced in volume to 34 L by concentration on a PES membrane having a molecular weight cutoff of 10,000 Daltons, operated at a temperature of about 55° C. At this point, the concentrated protein solution, with a protein content of 4.84 wt % was diafiltered with 68 L of RO water at about 59° C. The diafiltered protein solution was further concentrated to a volume of 28 L and then diafiltered with an additional 140 L of RO water at about 59° C. The protein solution before spray drying was recovered in a yield of 16.0% of the split pea flour. The concentrated and diafiltered protein solution was then dried to yield a product found to have a protein content of 104.30 wt % (N×6.25) d.b. The product was given designation YP07-006-12A YP701.

The weight of calcium chloride pellets (95.5%) used to produce the YP07-C06-12A YP701 was 34.7% less than would have been used if the 42.0 kg of yellow split pea flour had been extracted with 300 L of 0.13M CaCl₂.

### SUMMARY OF THE INVENTION

In summary of this disclosure, the present invention provides modified procedures for preparing pulse protein products in which the amount of calcium salt needed to effect efficient recovery of pulse protein product is reduced. Modifications are possible within the scope of this invention.

What we claim is:

1. A method of producing a pulse protein product having a protein content of at least about 60 wt % (N×6.25) on a dry weight basis, which comprises:
(a) effecting a first extraction of a pulse protein source with water in an amount of about 6 to about 20 L per Kg of pulse protein source to cause solubilization of a portion of the extractable pulse protein in the pulse protein source to form an aqueous pulse protein solution,
(b) adding calcium salt to the aqueous pulse protein solution to provide a calcium salt concentration in the solution of less than about 0.10 M, then separating the first residual solids to form a first aqueous calcium salt containing pulse protein solution,
(c) effecting a second extraction of the wet, first residual solids with an aqueous calcium salt solution to cause solubilization of further quantities of extractable pulse protein to form a second aqueous calcium salt containing pulse protein solution and second residual solids, said second extraction being effected using a calcium salt solution having a concentration to provide an overall calcium salt concentration of less than 1.0 M in an amount of about less than 5 L per Kg of wet first residual solids,
(di) separating the second aqueous calcium salt containing pulse protein solution from the second residual solids,
(ei) after said separation step, combining the first aqueous calcium salt containing pulse protein solution and the second aqueous calcium salt containing pulse protein solution to provide a combined aqueous pulse protein solution.
(fi) optionally diluting the combined aqueous pulse protein solution,
(gi) adjusting the pH of the combined aqueous pulse protein solution to a pH of about 1.5 to about 4.4 to produce an acidified aqueous pulse protein solution,
(hi) optionally clarifying the acidified pulse protein solution if it is not already clear,
(ii) optionally concentrating the acidified aqueous pulse protein solution while maintaining the ionic strength substantially constant by a selective membrane technique,
(ji) optionally diafiltering the optionally concentrated pulse protein solution, and
(ki) optionally drying the optionally concentrated and optionally diafiltered pulse protein solution, or
(dii) separating the second aqueous calcium salt containing pulse protein solution from the second residual solids,
(eii) optionally diluting each of said first and second aqueous calcium salt containing pulse protein solutions,
(fii) adjusting the pH of each of said first and second aqueous calcium salt containing pulse protein solutions to a pH of about 1.5 to about 4.4 to produce first and second acidified aqueous pulse protein solutions,
(gii) combining the first and second acidified aqueous pulse protein solution to provide a combined acidified pulse protein solution,
(hii) optionally clarifying the combined acidified pulse protein solution if not already clear,
(iii) optionally concentrating the combined acidified aqueous pulse protein solution while maintaining the ionic strength substantially constant by a selective membrane technique,
(jii) optionally diafiltering the optionally concentrated pulse protein solution, and
(kii) optionally drying the optionally concentrated and optionally diafiltered pulse protein solution, or
(diii) separating the second aqueous calcium salt containing pulse protein solution from the second residual solids,
(eiii) optionally diluting said first aqueous calcium salt containing pulse protein solution,
(fiii) adjusting the pH of said first aqueous calcium salt containing pulse protein solution solution to a pH of about 1.5 to about 4.4, to form a first acidified aqueous pulse protein solution,
(giii) combining the first acidified aqueous pulse protein solution with the second aqueous calcium salt containing pulse protein solution to form a combined aqueous pulse protein solution,
(hiii) optionally diluting the combined aqueous pulse protein solution,
(iiii) adjusting the pH of the combined aqueous pulse protein solution to a pH of about 1.5 to about 4.4 to produce an acidified aqueous pulse protein solution,
(jiii) optionally clarifying the acidified pulse protein solution if it is not already clear,
(kiii) optionally concentrating the acidified aqueous pulse protein solution while maintaining the ionic strength substantially constant by a selective membrane technique,
(liii) optionally diafiltering the optionally concentrated pulse protein solution, and
(miii) optionally drying the optionally concentrated and optionally diafiltered pulse protein solution, or
(div) optionally diluting the combined second aqueous calcium salt containing pulse solution and second residual solids,
(eiv) adjusting the pH of each of the first and second aqueous calcium salt containing pulse protein solutions to a pH of about 1.5 to about 4.4 to produce first and second acidified pulse protein solutions,
(fiv) separating the second acidified pulse protein solution from the second residual solids,
(giv) combining the first and second acidified pulse protein solutions to provide a combined acidified aqueous protein solution,
(hiv) optionally clarifying the combined acidified pulse protein solution if not already clear,
(iiv) optionally concentrating the combined acidified pulse protein solution while maintaining the ionic strength substantially constant by a selective membrane technique,
(jiv) optionally diafiltering the optionally concentrated pulse protein solution, and
(kiv) optionally drying the optionally concentrated and optionally diafiltered pulse protein solution, or
(dv) combining the first aqueous calcium salt containing pulse protein solution, the second aqueous calcium salt containing pulse protein solution, and second residual solids to provide a combined aqueous calcium salt containing pulse protein solution,
(ev) optionally diluting the combined aqueous calcium salt containing pulse protein solution,
(fv) adjusting the pH of the combined calcium salt containing aqueous pulse protein solution to a pH of about 1.5 to about 4.4 to produce an acidified aqueous pulse protein solution,
(gv) separating the second residual solids from the acidified aqueous pulse protein solution,
(hv) clarifying the acidified aqueous pulse protein solution if not already clear, and
(iv) optionally concentrating the acidified aqueous pulse protein solution while maintaining the ionic strength substantially constant by a selected membrane technique,
(jv) optionally diafiltering the optionally concentrated pulse protein solution, and
(kv) optionally drying the optionally concentrated and optionally diafiltered pulse protein solution.

2. The method of claim 1 wherein said calcium salt is calcium chloride.

3. The method of claim 1 wherein said initial addition of calcium salt is from a concentrated solution.

4. The method of claim 1 wherein, in the first extraction step, the extraction is effected using about 10 L of water per Kg of pulse protein source.

5. The method of claim 4 wherein, in the first calcium salt addition step, the calcium salt is added to a concentration of about 0.05 M.

6. The method of claim 4 wherein, in the second calcium salt extraction step, the extraction is effected using less than about 2 L calcium salt solution per Kg of wet, partially extracted pulse protein source.

7. The method of claim 6 wherein, in the second calcium salt extraction step, the overall concentration of calcium salt in the extraction is about 0.10 to about 0.15M.
